(19) United States
(12) Patent Application Publication
(10) Pub. No.: US 2012/0310814 A1
(43) Pub. Date: Dec. 6, 2012

(54) METHOD AND SYSTEM FOR FACILITATING COMMERCIAL PAPER FUNDING VIA A COMMUNICATION NETWORK

(76) Inventors: Cornelius Colin McNab, Riverdale, GA (US); Harendra B. Jani, Stratford, CT (US); Daniel Warren Pugh, Gatonsville, MD (US)

(21) Appl. No.: 13/572,694

(22) Filed: Aug. 12, 2012

Related U.S. Application Data
(63) Continuation-in-part of application No. 12/484,411, filed on Jun. 15, 2009.
(60) Provisional application No. 61/523,282, filed on Aug. 13, 2011.

(51) Int. Cl. G06Q 40/06; G06Q 40/04

(52) U.S. Cl. 705/37; 705/35

(57) ABSTRACT

A central computer system facilitates organizations and individuals using a communication network to negotiate commercial paper terms and to offer, sell, and buy commercial paper notes. The fundraiser/issuer uses a user device interface to input information about funding needs and repayment terms of commercial paper he intends to issue. The system, or a user device itself, generates an interface used by a potential or actual buyer that generates, or receives, a funding offer, or counteroffer in response thereto, respectively. The system facilitates generating and transmitting legal documents in the form of commercial paper notes, offerings, and sales via the communication network. The funding facilitator system can manage authentication credentials of the issuer and potential buyers to facilitate determining that either party has bound themselves to an offer, counteroffer, or acceptance. Issuer's and potential buyers' devices can authenticate the funding facilitator to verify the authenticity of a document received therefrom.

### CROSS REFERENCE TO RELATED APPLICATION

This application claims priority under 35 U.S.C. 119 to U.S. provisional patent application No. 61/523,282 filed on Aug. 13, 2011, entitled “Method For Facilitating Business Funding Via A Communication Network,” which is incorporated herein by reference in its entirety. This application also claims priority under 35 U.S.C. 120 to U.S. patent application Ser. No. 12/484,411 filed on Jun. 15, 2009, entitled “Method and system for facilitating fundraising via a communication network,” which is incorporated herein by reference in its entirety.

### FIELD

The present invention relates to business funding, and in particular, commercial paper offerings and sales directly between businesses and individuals using a communication network such as the Internet and World Wide Web.

### BACKGROUND

This specification describes technologies relating to commercial paper, business fundraising, and social networking services.

Commercial paper is usually a negotiable unsecured promissory note with a maturity of less than nine months offered to the public to fund business operating expenses or current assets. It is widely used in the commercial market by large corporations to meet short-term liquidity needs. Pursuant to current U.S. securities law, commercial paper with a maturity of less than nine months is deemed an exempt security, which therefore may be publicly offered and sold without registration with State or Federal securities agencies.

Investors often buy commercial paper with otherwise temporarily idle cash to earn a short-term return on that cash. Large companies usually issue commercial paper for cash management and liquidity purposes, such as monetizing a pool of receivables by selling commercial paper with maturity matched to the expected duration of that pool. Historically it has been difficult or impossible for small businesses to use commercial paper as a fundraising vehicle due to a lack of cost-effective tools for structuring the obligations and the absence of readily accessible markets in which to offer and sell such notes. This invention now offers an innovative way for small business owners to access the necessary structuring tools as well as a marketplace through which investors can find opportunities to fund small-business entrepreneurs with short-term cash needs.

Current U.S. law and regulation restricts commercial paper both in its duration and in the permissible use of the proceeds. Companies issuing commercial paper may use the funds only for “current transactions”, which translates to operating expenses or the purchase of current assets (i.e., short-term assets such as inventory, payroll or other short-term cash needs). Proceeds of commercial paper sales may not be used for financing fixed assets such as land, buildings or machinery. Although U.S. securities law deems commercial paper a security, if it matures in less than nine months then, by definition, the offer and sale of the instrument is exempt from registration with the Securities & Exchange Commission (SEC) and State securities administrators and may be offered publicly.

Under U.S. law, the sale transaction between the issuer (e.g., entrepreneur, borrower, business, or fundee) and the buyer (e.g., investor, lender, or funder) and the contents of the promissory note are governed by Uniform Commercial Code (U.C.C.) Articles 3 and 4. In various states of revision, Articles 3 and 4 of the U.C.C. have been adopted by all 50 States in the U.S. The first commercial paper was issued in the U.S. by Goldman Sachs in 1869, and over the past 140 years this investment vehicle has proved itself useful to large and well-known corporations. Only through the combination of commercial paper with a structuring and offering platform using a global communication network such as the Internet has it become possible for smaller businesses to take advantage of this powerful financing tool.

Five advantages of commercial paper include: First, commercial paper is a quick and cost-effective way of raising working capital that is typically cheaper than a bank loan or line-of-credit. Second, borrowers may get a lower discount/interest rate from investors and reduce the cost of funding. Third, commercial paper can be unsecured, and therefore does not create any liens on assets of the company. Alternatively, asset-backed commercial paper is secured by assets of the business. Fourth, commercial paper can be used for a wide range of maturities of less than nine months, which provides great flexibility for short-term financing. The minimum term is 1 day and the maximum term is usually nine months. Lastly, commercial paper that satisfies the requirements of securities law is exempt from Federal/SEC and State securities registration requirements which makes the process relatively easy, quick, and affordable.

Typically, commercial paper is offered for sale by a broker at a discount (i.e., less than the face value). For example, a commercial paper note with a face value of $100,000 may be issued and sold to a buyer at a discounted price of $97,000. This means that the issuer (i.e., borrower) would pay $100,000 to the buyer (i.e., lender) at maturity.

There are four overarching problems with the traditional commercial paper process that are addressed by this invention: First, small businesses and startups have difficulty raising working capital and have been underserved by the traditional commercial paper market, which targets borrowers who are large corporations with established credit and lenders who are institutional investors seeking to invest over $100,000 per transaction. Second, traditional models of commercial paper are complicated and not conducive to direct negotiation between small business borrowers and lenders who are individuals. Third, commercial paper broker-dealers typically impose high fees that are unaffordable to most small businesses. Lastly, there is no online marketplace for buying and selling commercial paper notes issued by small businesses, and the lack of a ready secondary market for small business commercial paper renders these instruments relatively illiquid.

### SUMMARY

In all the embodiments described below, it is to be understood that the invention is capable of accommodating potentially multiple investors, buyers, lenders, or funders and multiple entrepreneurs, issuers, borrowers, fundraisers, or businesses involved in a single business fundraising transaction.

The embodiments described herein facilitate direct commercial paper offerings, sales, and purchases between small businesses and individual investors online. The invention combines several existing paradigms—traditional commercial paper transactions, business fundraising, information technology, and social network funding—to create a novel system for issuing and buying commercial paper.

The described methods enable management of commercial paper transactions virtually, by employing a social network fundraising model in which an entrepreneur creates an offering for sale of commercial paper notes online, invites individuals who are socially connected with the entrepreneur or business to join and participate in the offering, and may sell notes to the individual investors either at a negotiated discount rate, at a negotiated interest rate, or with a flat upfront fee payable to each buyer. Such commercial paper offering and management occurs virtually via a communication network such as the Internet and/or telephony; and the individuals who may participate in the offering may include various levels of the entrepreneur's social network including friends, family members, business associates, and/or even strangers, any of whom may learn of the offering by searching/browsing a funding facilitator website online, by receiving a communication from an online funding facilitator, by direct communication with the entrepreneur, by social network communications, or by secondary social communications among members of the entrepreneur's extended social network.

First, the described methods serve small businesses which typically have difficulty raising relatively small amounts of working capital (e.g., $20,000) due to lack of established credit and the administrative burden and expense of traditional commercial paper systems. Second, the described methods simplify the commercial paper funding process for issuers and for buyers who are individual investors. Third, the described methods enable direct negotiation of terms and execution of the sale and purchase transaction without expensive broker fees. Fourth, the described methods create an online marketplace for buying and selling commercial paper notes issued by small businesses. Fifth, the described methods reduce the risk to any individual investor by enabling multiple investors to share the loan risk by spreading the risk across multiple investors. If a greater number of socially-connected investors participate, the risk experienced by any individual investor necessarily decreases. Sixth, the described methods connect friends, family, and other contacts in raising funding. The parties in traditional commercial paper transactions are strangers, but this small business commercial paper fundraising method enables small businesses and entrepreneurs to tap the power of their social network in solving the problem of startup business fundraising.

These and other aspects, features and advantages can be combined and are further appreciated from the accompanying description of the embodiments and drawings.

The described methods combine and apply several existing principles in commercial paper, business finance, social networking, social funding, information technology, Internet technology, and telephony. There is an opportunity to improve traditional modes of commercial paper by applying new paradigms (such as small business, direct funding, social networking) and technology (such as computers, communications networks such as the Internet, and interactive voice response—IVR).

### BRIEF DESCRIPTION OF THE DRAWINGS

The above and other objects of the present invention will be apparent upon consideration of the following detailed descriptions, taken in conjunction with the accompanying drawings, in which like reference numerals refer to like parts throughout, and in which:

FIG. 1 illustrates a flowchart demonstrating a system framework of an embodiment for facilitating a commercial paper offering and investment using the present invention.

FIG. 2 illustrates a flowchart demonstrating an embodiment of the invention which integrates an online payment processor and the transfer of funds between financial institutions, entrepreneurs, investors, and the facilitating entity utilizing the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be more thorough, and will help convey the scope of the invention to those skilled in the art. Aspects of the present invention may be embodied as a method, financial management system, computer program, or software product. Furthermore, aspects of the invention may be targeted for use by individuals and groups, consumers and businesses.

In the following description of the preferred embodiment, reference is made to the accompanying figures that form a part hereof. It is to be understood that while the example of an entrepreneur and investor is used, other embodiments for the issuer/fundraiser and buyer/funder may be utilized without departing from the scope of the present invention.

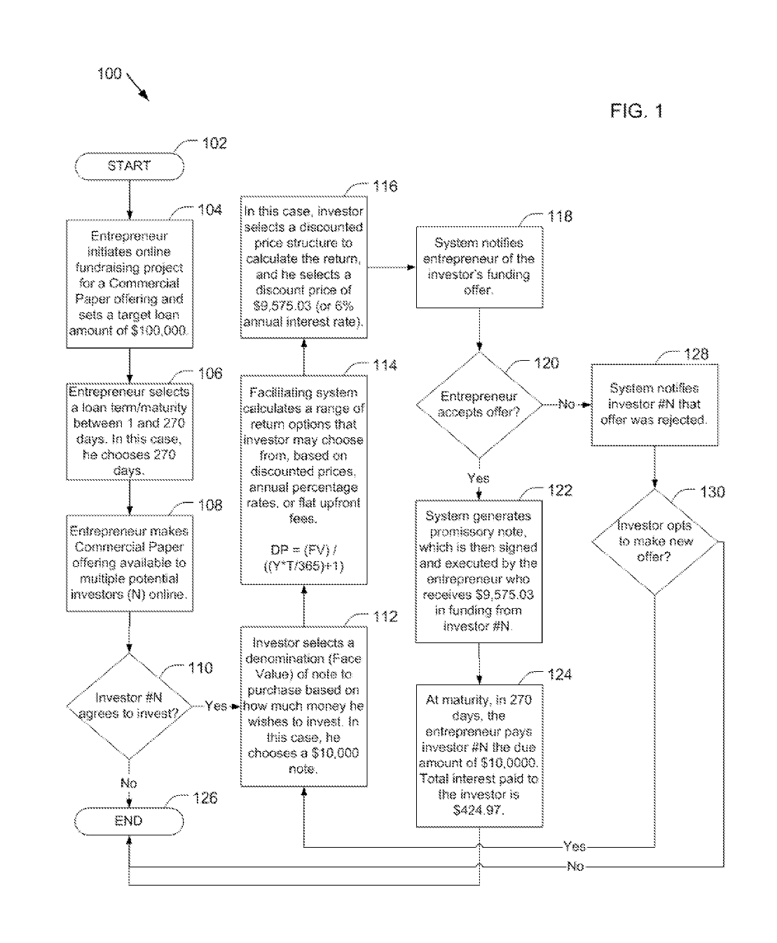

FIG. 1 illustrates a flow diagram of a method 100 for commercial paper fundraising in which an entrepreneur sets up a new fundraising project to raise capital by issuing commercial paper notes, which investors may purchase and earn a return on investment.

As a funding facilitator, a social network fundraising system allows an entity seeking funding to create a funding request and either forward the request to preselected individuals or entities privately, or make the request publicly available. If a potential investor wishes to contribute funds, it establishes an account and login credentials with the funding facilitator and authorizes a transfer of funds from its account to a payment processor account associated with an entrepreneur at the funding facilitator. The funding facilitator may initiate repayments to investors who are lenders according to a repayment schedule which may reflect interest, or which may account for a face value discount or a lump-sum payment to the lender at issuance.

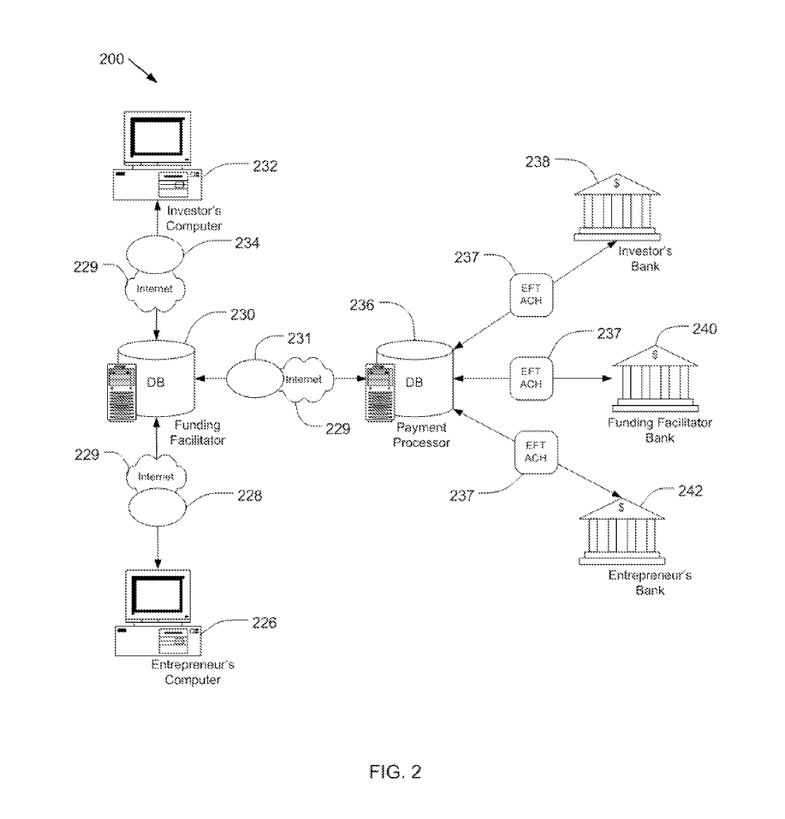

Returning to discussion of FIG. 1, which discloses an embodiment of the commercial paper fundraising method 100. Method 100 starts at step 102. An entrepreneur wanting to raise funds for their business comes to the funding facilitator 230, as shown in FIG. 2, here in the form of a website, and registers their business including business description, relevant financial information, proposed use of funds, and a target amount to be raised. The entrepreneur chooses the Term (i.e., maturity ranging from one day to nine months) when he sets up his commercial paper fundraising project, so that all the payments for his fundraising project would be due on the same day, and the entrepreneur can easily manage his cash flow and plan for the short-term hit to his budget. The entrepreneur will then provide the funding facilitator 230 with a list of contacts or social connections, along with contact information such as email address for each, to approach on their behalf, explaining the website's role in facilitating the transaction between the entrepreneur and investor. The funding facilitator 230 can also establish a connection between parties that do not have a familial or prior relationship outside the one created by the website, such as peers. The funding facilitator 230, using the power of the social network applications, which can access information from multiple commercial and/or publicly available social networks, as well as proprietary networks hosted by the facilitator, and which are embedded within the system framework presented by the invention, can establish connection, or find matches, between multiple entrepreneurs and investors based on a single fundraising project, funding request, or commercial paper offering. The system framework can be used by potential investors as a means of searching for and identifying investment opportunities that the investors consider attractive based on their individual criteria. The system may also generate a creditworthiness rank, or score, that can be displayed on the entrepreneur's social network profile. In addition, the system may indicate a ranking of how closely matched a potential investor is to a potential commercial paper offer based on a risk tolerance value associated with the potential inventor and based on the creditworthiness ranking, or score, or the entrepreneur.

The funding facilitator system 230 invites the investor to the entrepreneur's section of the website to view the information regarding the business venture, fundraising project, and commercial paper offering. The investor, after having reviewed the information, is presented with an opportunity to invest via the commercial paper offering. The investor chooses the amount to invest, and that amount is the face value, or denomination, of the note, where the maximum face value is equal to 100% of the target amount to be raised. The funding facilitator 230 system calculates and generates a user interface for display on a device of the potential investor that displays options for discounted price, equivalent annual percentage rates, or flat upfront fees that the investor can choose from in order to determine potential return. For example, in the flat fee scenario, the entrepreneur may offer to sell a $10,000 commercial paper note (face value) to an investor for $10,000 and the entrepreneur may pay a one-time flat fee (e.g., $400 fee where the maturity/term is 270 days, or $200 fee for maturity of 135 days) to the investor up-front, followed by a payment of $10,000 to the investor at maturity. The flat upfront fee may vary based on the funding amount and the maturity. In all cases, the entrepreneur, using a user interface generated by the funding facilitator system 230, has the option to accept or decline the specific terms offered by the investor, and the investor has the option to offer various funding amounts and interest rates, discount rates, and/or fees for providing the capital.

At steps 104 and 106, the entrepreneur starts a fundraising project, hosted by funding facilitator system 230, where he indicates the total amount that he seeks to raise (e.g., $100,000), when he will pay it back (e.g., 270 days maturity), and whether his project is public or private (e.g., accessible by invitation only). These are the entrepreneur's predetermined/preset criteria, which the entrepreneur typically enters through a user interface on a device. The interface may be hosted as a web site by funding facilitator 230, or, the interface may be an application running on a user device such as a personal computer, tablet, smart phone, or the like. The user interface used by the investor/potential investor can comprise a hosted web site, an application on a user device such as a tablet, smart phone, personal computer, and the like.

At step 108, whether the project is public or private, the funding facilitator 230 enables the entrepreneur to use the user interface to invite his social network of contacts to participate as investors, and the funding facilitator 230 may provide a ranking that indicates which contacts are most likely to invest. The funding facilitator 230 enables each investor to invite their social network of contacts to participate as investors too. This applies to all public projects and only private projects, accessible by invitation only, that the investor has been invited to.

If an investor agrees to invest, at steps 112 and 116, the funding facilitator 230 enables the investor to make a funding offer, which includes the amount he is willing to invest (e.g., $10,000) and the rate of return or fee (e.g., 2% discount rate, 4% interest rate, or $200 fee). These are two funding preferences/terms that each investor inputs/selects. Additionally, there are other funding preferences that the investor may use as criteria to determine whether or not to make an offer—including, but not limited to: the investor's relationship to the entrepreneur (e.g., relative, friend, co-worker, stranger); the location of the business (e.g., state and/or city); whether the entrepreneur has completed/uploaded a business plan; the stage of the business; the business entity/structure (e.g., C corporation, limited liability company, sole proprietorship); the industry of the entrepreneur's business (e.g. retail); the uses of funding (e.g., marketing, payroll); whether the entrepreneur has offered non-financial rewards to investors (e.g., a free trial or discount); and, whether the entrepreneur has raised previous funding. Alternatively, an investor may pre-select its funding preferences and grant the funding facilitator 230 permission to make funding offers automatically whenever a fundraising project matches the investor's funding preferences. This applies to all public projects and only private projects, accessible by invitation only, that the investor has been invited to.

At step 118, when an investor makes a funding offer, the funding facilitator 230 generates a draft commercial paper note, containing the selected terms, that is binding upon the investor only, and then notifies the entrepreneur that he has received a funding offer. The funding facilitator 230 may indicate that the investor has obligated himself, or herself, by including a unique identifier associated with the investor, that may be generated, for example, by applying a hashing algorithm to a secret key and a user ID of the investor. Typically, the secret key may only be known to the user and to the funding facilitator 230, which may send a confirmation message confirming the offer to the investor via e-mail, or other electronic means, or even via voice mail or regular U.S. Mail. In addition, other means of identifying the investor and confirming that he, or she, has committed themselves, can also be used. The funding facilitator 230 enables the entrepreneur to view the draft commercial paper note and either accept or reject the funding offer.

If the entrepreneur accepts the offer, at step 122, the funding facilitator 230 enables the entrepreneur to execute the agreement by signing the commercial paper note and arranging for payment from/to the investor. Similar methods for committing the investor can be used to indicate that the entrepreneur has committed himself to the terms; this may occur concurrently with, and accompany, the offer from the entrepreneur. At step 124, when the maturity date arrives, the funding facilitator 230 sends a repayment reminder to the entrepreneur that each note is due, e.g., in the amount of $10,000.

If the entrepreneur rejects the offer, at step 128, the funding facilitator 230 removes the draft commercial paper note and notifies the investor that the previous offer was rejected by the entrepreneur. Then, at step 130, the funding facilitator 230 enables the investor optionally to make a new funding offer and proceed to step 112, or alternatively the entrepreneur may propose new terms to the investor. This sequence of steps may be repeated until the entrepreneur and investor have reached a negotiated agreement regarding the terms of the commercial paper note.

The funding facilitator 230 enables investors to make funding offers until either the total target amount ($100,000) is raised or the fundraising project's end date is reached. If the project's end date is reached and the total amount has not been raised, then the funding facilitator 230 enables the entrepreneur optionally to extend the fundraising project for an additional period of time, such as one month.

As explained, the transaction between the parties, the entrepreneur(s) and investor(s), interest calculations, account balances, and instructions conveyed between party accounts and all payment processing entities involved will be generated by the web-based facilitating entity 230.

FIG. 2 shows another embodiment of the fundraising facilitation system. In the embodiment shown in FIG. 2, the funding facilitator 230 facilitates communications between the entrepreneur and investor, and then relays their instructions on fund transfers to an online payment processor 236. The instructions sent by the facilitating entity empowers the online payment processor 236 as the primary means for initiating fund transfers from all the accounts involved in the transaction between the entrepreneur(s) and investor(s). In this particular embodiment, all the parties involved, including entrepreneur(s), investor(s), and the facilitating entity, have their bank accounts linked through the online payment processor 236 which is granted access to the accounts by their respective owners. Thus, the instructions from the facilitating entity make the online payment processor 236 the initiator of fund transfers and therefore critical to maintenance of the framework of the invention. In this embodiment, entrepreneurs and investors enjoy the additional security of using a mutually respected third-party payment processing service provider.

FIG. 2 illustrates a system for facilitating an electronic fund transfer transaction. The figure illustrates how account data and funds data travel between the various entities with the funding facilitator 230 as intermediary. In the illustrated embodiment, entrepreneur uses his computer 226 to login and send, or receive, an account data message 228 over a communication network, such as, for example, the Internet, to, or from, the funding facilitator's database 230. The data message in this case may contain a funding request that the entrepreneur posts on a website that invites his friends and family to provide funding for his business venture.

An investor uses his computer 232 to login and send, or receive, an account information message 234 over the communication network to, or from, the funding facilitator's database 230. Account information message 234 may contain a funding request that the investor may view, and then the funding facilitator 230 presents options among which the investor selects in order to specify the investor's desired funding amount and terms of the funding offer.

The funding facilitator's database 230 can communicate with the entrepreneur's and investors' computers 226 and 232, respectively, via the Internet, for example sending an investor a data message regarding business expenditures that the entrepreneur has made using the proceeds of the commercial paper offering. The funding facilitator's server, and database 230 can send the entrepreneur an email reminder, or notification, when a loan payment is due.

The funding facilitator's server, and database 230, also communicates with the payment processor's 236 server, and database, 236, sending and receiving data 231 via a file transfer protocol (“FTP”) data import from the one database to the next. For example, the funding facilitator server/database 230 can import a data log, or report, containing a list of purchases made in one week using the entrepreneur's account, or funding identifier. The report of purchases may also include purchases made by all entrepreneurs who use the funding facilitator 230.

The payment processor's server/database 236 may receive, or import, a data message from the funding facilitator 230 in the form of instructions regarding which accounts should be debited or credited and by how much. For example, payment processor server/database 236 may import data from the funding facilitator server/database 230 regarding how much to pay each investor when the entrepreneur makes a loan payment. The amounts may be paid to various investors in proportion to the amounts loaned, as described elsewhere herein.

Payment processor server/database 236 communicates with banks in order to send, or receive funds, via electronic funds transfer-automated clearinghouse (EFT-ACH). In the case of a loan, server/database 236 may generate an EFT-ACH transaction message 237 that debits funds from an investor's bank account at bank 238, places a five percent (for example) commission from the debited funds in the funding facilitator's bank account at bank 240 as a service fee, and then credits the remaining funds to entrepreneur's account at entrepreneur's bank 242. Alternatively, in case of a loan in repayment, server/database 236 may communicate the appropriate account numbers to banks 238, 240, and 242, and withdraw funds from entrepreneur's bank 242, place a two percent (for example) service fee, or commission, in the funding facilitator's bank 240 bank account, and then deposit the remaining funds to investor's bank account at bank 238. Finally, payment processor server/database 236 relays a repayment transaction message containing information regarding the repayment to funding facilitator's server/database 230 during the next FTP data import.

In other embodiments, the funding facilitator system may utilize other communications networks such as interactive voice response (IVR) systems to enable members to manage their commercial paper offerings, sales, and purchases via telephone. This convenience would be offered to entrepreneurs and investors in lieu of or in addition to using an Internet-enabled computer or mobile device. And the IVR would offer further automated convenience. Most people have access to, are familiar with, and are willing to use a telephone for such transactions as electronic banking. A voice recognition algorithm could be used for authentication and signature of one who agrees to be obligated in lieu of a manual signature of the obligor.

In another embodiment, the funding facilitator hosts an auction where an investor/lender with lowest incentive/interest rate/fee requirement wins the ability to fund the project and purchase the note.

In another embodiment, the funding facilitator system can facilitate buying and selling commercial paper notes on a secondary market, enabling buyers to sell the notes they hold to other secondary buyers before the notes reach maturity. The funding facilitator could maintain the address and other contact information of the one, or more, secondary buyer(s). The facilitator system could use this information for automatically facilitating auction of, or other means of offering and selling, outstanding commercial paper notes, as well as the sending of payments from the secondary buyers to the primary buyers and the sending of repayments from the issuers to the secondary buyers of the commercial paper. The funding facilitator system also could use this information, including the project associated with the commercial paper offering, whether the secondary buyer bought all, or part of, the original commercial paper notes, for sending future offers to the secondary buyer(s) even if they themselves did not use the funding facilitator to purchase the commercial paper.

It will be appreciated that reference to a party to a transaction (i.e., an entrepreneur seeking to raise money, or a potential investor, or investor) performing an action typically implies that the party uses an interface generated by the host facilitating system 230. The interface may also be generated by an application running on a personal device used by the particular party. In addition, conventional means, such as for example, telephone conversations with operators at central location of the funding facilitator, or via mail, can also be used to implement the steps claimed in the claims. Other methods and systems known in the art, for example cloud computing and hosting and distributed computing systems and components, can perform the functions and serve as the components of the funding facilitator system 230.

What is claimed is:

1. A method for offering commercial paper wherein an issuer and one or more potential buyers join and participate in an offering of commercial paper via a funding facilitator system, comprising:
generating a user interface for presenting information regarding an investment opportunity, having predetermined criteria, for presentation on a communication device;
receiving funding preference information values input by a potential buyer with a user interface running on a device used by the potential buyer wherein the funding preference information values correspond to one or more investment preferences of the potential buyer,
automatically determining whether at least one of the funding preference information values meets the predetermined criteria; wherein the criteria relates to specified investment terms that the issuer will accept; and
automatically generating a financial instrument or promissory note agreement if at least one of the funding preference information values meets the predetermined criteria.

2. The method according to claim 1, wherein the issuer is a small businesses (as defined by the US Small Business Administration), small-business owners, or agent/representative.

3. The method according to claim 1, wherein potential buyers are individuals (e.g., members of the entrepreneur's social network, including friends and family members), groups, or entities.

4. The method according to claim 3, wherein potential buyers are invited by the issuers, by other potential buyers, or buyers to access the information regarding the investment opportunity.

5. The method according to claim 2, wherein an issuer and a potential buyer negotiate the at least one of the terms of a group of potential commercial paper terms—including funding amount, interest rate, rate of return, and maturity date—directly between the two parties in a transaction via the funding facilitator system.

6. The method according to claim 1 wherein the predetermined criteria corresponds to a predetermined level of matching of characteristics between the investment opportunity and the potential buyer according to social networking information from a social network profile of the potential buyer.

7. A computer system configured for performing steps comprising:
generating a user interface for presenting information regarding an investment opportunity having predetermined criteria via a user interface on a computer device in communication with the Internet;
receiving funding preference information values input through the user interface designating one or more investment preferences of a potential buyer, automatically determining whether at least one of the funding preference information values meets predetermined criteria, wherein the criteria relates to specified investment terms that the issuer will accept; and
automatically generating a financial instrument or promissory note agreement if at least one of the funding preference information values met the predetermined criteria.

8. The system according to claim 7, wherein the issuer is a small businesses (as defined by the US Small Business Administration), small-business owners, or agent/representative.

9. The system according to claim 7, wherein buyers are individuals (e.g., friends and family members), groups, or entities.

10. The system according to claim 9, wherein buyers are invited by the issuers, by other potential buyers, or buyers, to access the information regarding the investment opportunity.

11. The system according to claim 8, wherein issuers and buyers negotiate the terms—including a funding amount, an interest rate, a return rate, and maturity date—directly between the two parties in a transaction via interfaces generated by funding facilitator software running on the computer system.

12. The system according to claim 11, wherein the predetermined criteria corresponds to a predetermined level of matching of characteristics between the investment opportunity and the potential buyer according to social networking information from a social network profile of the potential buyer.

13. A method running on a user device, remote from a funding facilitator system, for facilitating a potential buyer in negotiating a commercial paper purchase with an issuer thereof, comprising:
generating a user interface for presenting information regarding an investment opportunity having predetermined criteria;
receiving funding preference information values input through the user interface designating one, or more, investment preferences of the potential buyer,
generating a funding offer message responsive to the investment opportunity based on the funding preference information values;
transmitting the funding offer message to the funding facilitator system;
receiving confirmation, or acceptance, of funding offer corresponding to the funding offer message;
generating a commercial paper document reflecting the terms of the confirmed or accepted funding offer; and
storing the commercial paper document to a memory.

14. The method of claim 13 wherein the user device is a mobile device such as a smartphone or tablet having communication capabilities.

15. The method of claim 13 where the commercial paper document is a financial instrument or promissory note agreement.

16. The method of claim 14 wherein the mobile device uses a unique identifier particular to the potential buyer to sign the funding offer message.

17. The method of claim 14 wherein the mobile device authenticates the funding facilitator system to confirm that the funding facilitator system transmitted the investment opportunity information, funding offer message, acceptance of the funding offer, confirmation of the funding offer, or counteroffer to the funding offer related thereto, received by the mobile device.

18. The method of claim 13 further comprising authenticating, with a user device of the issuer, the funding facilitator system to confirm that the funding facilitator system transmitted the funding offer.
